(19) United States
(12) Patent Application Publication
(10) Pub. No.: US 2012/0153797 A1
(43) Pub. Date: Jun. 21, 2012

(54) Lamp body structure comprised of heat-dissipating fins

(76) Inventor: Taiming Chen, Fremont, CA (US)

(21) Appl. No.: 12/928,644

(22) Filed: Dec. 17, 2010

(51) Int. Cl. H01J 61/52

(52) U.S. Cl. 313/46

(57) ABSTRACT

This apparatus is a lamp body structure comprised of a plurality of heat dissipating plates. Each said plate has mounting seats for Light emitting elements such as LED to mount on. There are also means to connect said heat dissipating plates together to form a rigid lamp body structure.

### FIELD OF THE INVENTION

The present invention relates, in general, to a lighting apparatus with utilization of light emitting elements and, more particular, this invention relates to a lamp body structure to be used with light emitting diodes (LED).

### BACKGROUND OF THE INVENTION

1. Field of the Invention

The present invention relates generally to electrical lighting apparatus, and more particularly to a lamp apparatus comprising a plurality of light emitting elements, such as light emitting diodes(LED), incorporated with heat dissipation device (heat sink) for dissipating waste heat and keeping operation temperature low. The present invention lamp body structure includes heat dissipating fins and connecting structure to allow highest rigidity and heat dissipation while keep the weight and cost down.

2. Description of the Related Art

A number of different principles of LED lamps and LED light bulbs have been developed over the years. Since LED operates the best at lower temperature, many lamps or bulbs employ heat dissipation device that transfers heat generated within a solid material to a fluid medium, such as air or a liquid, (so call heat sink).

A conventional heat sink has a block of base and many heat-dissipating fins. The item requires heat dissipation is designed to attach to the base of heat sink for quickly transmit waste heat to neat by fins and eventually conduct heat exchange to ambient air. The block heat sink base is especially helpful to spread out focused heat point to wide area of heat dissipating fins.

Typically LED lamp employs multiple light emitting elements that located at a wider area of circuit board, and then said circuit board attaches to base of heat sink. This conventional thinking of combining pre-made LED circuit board and pre-made heat sink method does not help airflow rate near the heat sink base; but increase the weight of lamp.

### BRIEF SUMMARY OF THE INVENTION

The present invention comprises a plurality of heat dissipating fins, said fins having mounting seats for Light emitting elements to directly mount on; together with connecting means to connect said heat dissipating fins to form a rigid lamp body. However, the connecting mean is not meant to be entire base wall which may stop airflow to and from its direction.

Assuming said mounting seat mounts LED off a fixed angle from said fin's edge, by controlling the contour of fin is made of, the light output angle of each LED attaching to said fin can be arranged. Base on the same reason, by controlling the mounting angle of each fin can control light output angle of all LEDs mounted on that fin. A lamp of present invention may comprise of a plurality of fins aligned to different angles to spread out light output.

Compare to conventional heat sink design, the present invention do not have a block heat sink base. Therefore, there is one less wall to block air flow. This is especially important, when lamp is mounted horizontally, wherein air flowing from below is not blocked.

### BRIEF DESCRIPTION OF THE DRAWINGS

FIG. 1 is a view of a heat dissipating fin with LED mount on it.

FIG. 2 is a perspective view of a lamp comprising of heat-dissipating fins with LED mount on them.

FIG. 3 is a perspective view of a lamp comprising of heat-dissipating fins.

FIG. 4 is a perspective view of a lamp comprising of heat-dissipating fins.

FIG. 5 is a sectional view of a lamp comprising of heat-dissipating fins.

FIG. 6 is a perspective view of a lamp comprising of heat-dissipating fins.

FIG. 7 is a view of a heat dissipating fin with LED mount on it.

FIG. 8 is an exploded view shows portion of one fin and one connecting mean.

FIG. 9 is an exploded view shows portion of one fin.

### DETAILED DESCRIPTION OF THE PREFERRED EMBODIMENT

Prior to proceeding to the more detailed description of the present invention, it should be noted that, for the sake of clarity and understanding, identical components which have identical functions have been identified with identical reference numerals throughout the several views illustrated in the drawing figures.

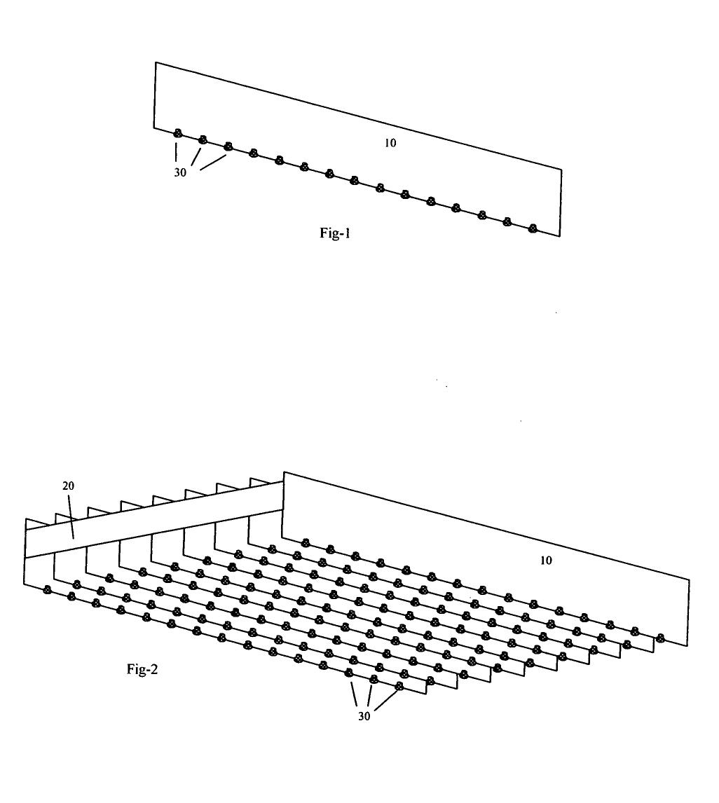

FIG. 1 shows a heat-dissipating fin 10 with a plurality of Light Emitting Diodes (LED) 30 mounted on it.

FIG. 2 shows a perspective view of lamp comprising of a plurality of heat-dissipating fins 10 with LEDs 30 mounted. There are connecting means 20 to connect said fins and to form a rigid lamp body. There are opening space between said fins to allow air to flow between them.

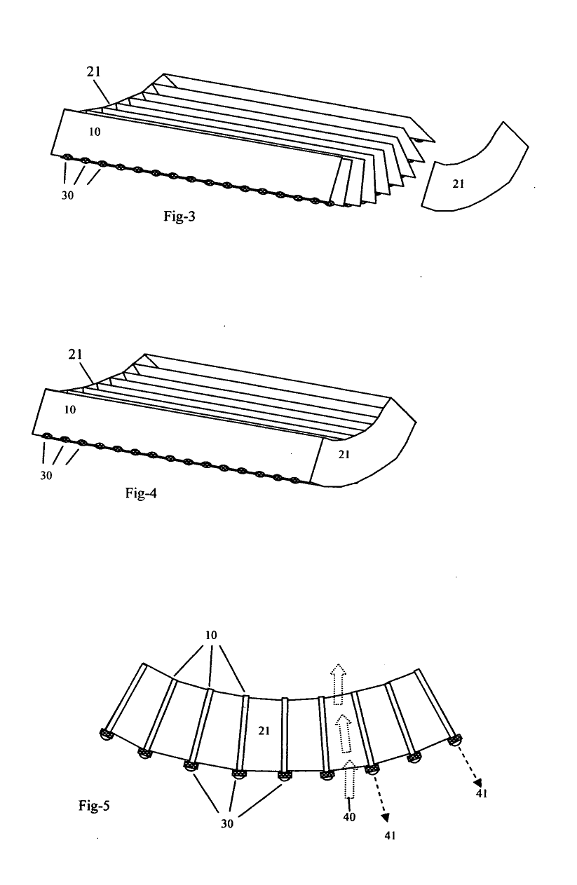

FIG. 3 shows a perspective view of lamp comprising of a plurality of heat-dissipating fins 10 with LEDs 30 mounted. There are one connecting mean 21 connects said fins and another connecting mean 21 yet to connect to fins 10. Said fins 10 are pointing to different directions. The light output of LED can also point to different direction.

FIG. 4 shows a perspective view of lamp same as FIG. 3; yet with the separated connecting mean 21 now is attaching to said heat dissipating fins 10.

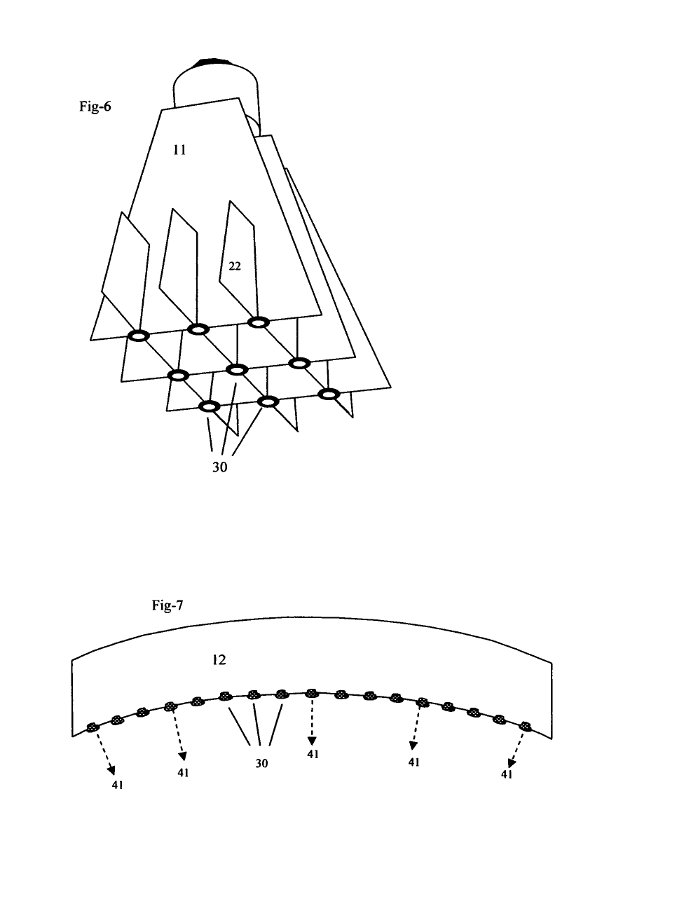

FIG. 5 is a sectional view of a lamp comprising of heat-dissipating fins 10. In this Figure, it clear show said fins 10 are pointing to different directions and there is space in between fins 10 to allow air 40 flow through.

FIG. 6 shows a perspective view of lamp comprising of a plurality of heat dissipating fins 11 with LED 30 mounted. There are connecting means 22 to connect said fins 11. This figure also show said connecting means 22 can also be heat dissipating fins.

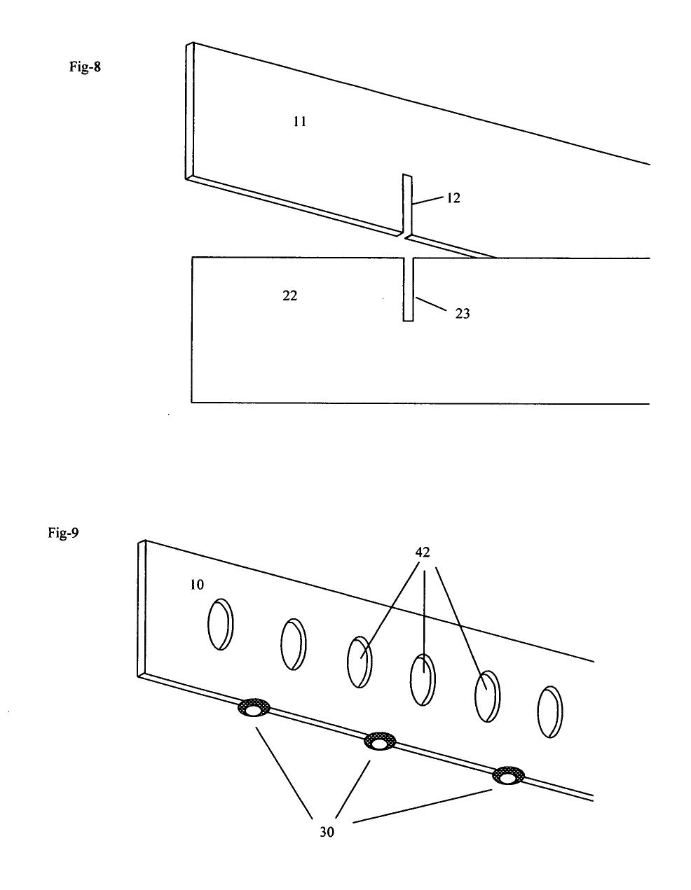

FIG. 7 shows a heat-dissipating fin 12 with a plurality of Light Emitting Diodes(LED) 30 mounted on it. The fin is not rectangular shape; therefore the light output of LED 30 can be spread out to different directions

FIG. 8 is an exploded view shows there are cut out slot 12 on said fin 11 and the slot 12 is having the width set same as the thickness of one connecting mean. And there are cut out slot 23 on connecting mean 22 and said cut out slot 23 is set to have width same as one said fin 11; and they can interlock into each other.

FIG. 9 is an exploded view shows there are holes 42 punched out on said fin 10 to reduce weight and increase air contacting surface area.

1. a lamp body structure comprising:
a plurality of heat dissipating plates, said plate having mounting seats at a edge for Light emitting elements to mount on; and
means to connect said heat dissipating plates together to form rigid body structure.

2. The lamp body structure of claim 1 wherein said connecting means are also heat dissipating plates.

3. The lamp body structure of claim 1 wherein said plates are having cut out slots with width set same as the thickness of one connecting mean; and connecting means are having cut out slots with width set same as the thickness of one said plate and they can interlocking into each other via said slots of both sides.

4. The lamp body structure of claim 1 wherein said mounting seat is formed by cutting out or bent material from said heat-dissipating plate.

5. The lamp body structure of claim 1 wherein the light output direction of each light emitting element is off a fixed angle from the edge of said plate; by setting the contour of the plate is made, the light output direction of Light emitting elements can be set.

6. The lamp body structure of claim 1 wherein said plates are aligned to a plurality of different directions from lamp, by setting up the alignment of said plates, the light output direction of all light emitting elements of each plate can be arranged.

7. The lamp body structure of claim 1 wherein a connector to power socket is attached to lamp body.

8. The lamp body structure of claim 1 wherein a circuit house is attached to lamp body.

9. The lamp body structure of claim 1 wherein said plates are having holes punched out through out its body to further reduce weight and increase air contact surface area.
